(19) United States
(12) Patent Application Publication
(10) Pub. No.: US 2013/0149509 A1
(43) Pub. Date: Jun. 13, 2013

(54) Decorative and Protective Covering Process and System

(71) Applicants: Steven J. Federico, Wilmette, IL (US); Dianne Fasano, Lake Geneva, WI (US); Robert A. Fasano, Lake Geneva, WI (US); Matthew L. Brueck, Wildwood, IL (US)

(72) Inventors: Steven J. Federico, Wilmette, IL (US); Dianne Fasano, Lake Geneva, WI (US); Robert A. Fasano, Lake Geneva, WI (US); Matthew L. Brueck, Wildwood, IL (US)

(73) Assignee: Pho-Covering LLC, Wilmette, IL (US)

(21) Appl. No.: 13/324,516

(22) Filed: Dec. 13, 2011

(51) Int. Cl. B32B 3/00; B32B 37/02; B32B 38/10

(52) U.S. Cl. 428/203; 156/247

(57) ABSTRACT

A decorative and protective covering process and system can wrap, decorate and protect: a cabinet, countertop, table, furniture, backsplash, wall tile, shower surround, refrigerator, dishwasher, outdoor grill, air conditioner, elevator, door, wall, floor, ceiling, window sill, window frame, door frame. The wrapped product can be used in: a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured home, apartment, restaurant, house, hotel, motel, hospital, nursing home, mobile home, trailer, RV interior, boat interior, train interior, bus interior, rehabs, rental unit, condominium, home, townhome, gazebo, porch, outdoor bar, grilling area, etc. The wrapped product can provide a composite assembly with a multi-layer laminated protective decorative cover.

### BACKGROUND OF THE INVENTION

This invention relates to a decorative covering process and system.

Many home and business owners desire a personal and unique appearance of different spaces in their interior dwelling. These areas include kitchens, bathrooms, offices, garages, and other areas for meetings or entertainment. This desire is often expensive and impractical. Furthermore, certain home types such as motor homes and boats have weight restrictions making it difficult to provide the traditional home details. Owners and builders are continuously searching for alternatives to expensive construction and remodeling of interior surfaces. Accordingly, there is an economical need for new options to costly remodeling and construction for both commercial and residential development.

In the past, mobile media wraps, vinyl graphics, banners, truck lettering, printed marketing material, and designs have been used on racecars, trucks, buses, trains and boats. Also in the past various trim kits, panels, decals overlays, paint and coatings have been used on refrigerators, cabinets, walls and other items. These prior mobile media wraps, vinyl graphics, banners, truck lettering, printed marketing materials, advertising, designs, trim kits, panels, decals, overlays, paint and coatings have met with varying degrees of success.

It is, therefore, desirable to provide an improved decorative and protective covering process and system, which overcomes most, if not all of the preceding problems.

### BRIEF SUMMARY OF THE INVENTION

An improved decorative and protective covering process and system is provided which is efficient, attractive, economical, customer friendly, and durable. Desirably, the improved decorative covering process and system produced unexpected surprisingly good results.

The improved decorative and protective covering process and system provides an economical and efficient alternative for decorating, modeling and/or rehabilitation of almost any interior or exterior surface in an apartment, restaurant, home, hotel, hospital, or nursing home with an enhanced and pleasing look of quality. Also, the improved decorative and protective covering process and system offers an excellent alternative to costly remodeling and construction, as well as provides an economical choice for almost every building owner and developer during construction and remodeling.

The improved decorative and protective covering process and system provides photographed tile, stone, granite and solid colors images which can be designed and printed permanently on pressure sensitive, durable adhesive vinyl for use in decorating, modeling, rehabilitation and design by applying it to walls, cabinets, and/or countertops in almost any residential dwellings, mobile motor homes, boats, and commercial spaces, and can be used in kitchens, backsplashes, cabinets, countertops, entryways, dining rooms, family rooms, bedrooms, bathrooms, bars, pantries, basements, garages, hotel rooms, hospitals, office and almost any other interior surfaces.

The improved decorative and protective covering process and system can provide printed patterns of tile and stone on durable pressure sensitive material that can be used for a back splash, wall tile, or shower surround. Solid colors and other patterns can be used for almost any other interior flat surface, such as cabinets or countertops. Tile patterns can be developed from real tile and created, designed, and assembled by tile and graphic designers. Products produced by the improved decorative and protective covering process and system are easily applied and removed from most surfaces without any dust or mess. The durability of the improved decorative and protective covering process and system provides a long term solution for a great aesthetic look or a temporary option given the ease of application and removal.

The improved decorative and protective covering process and system can provide a high definition, photo-quality picture of tile patterns, stone, granite, marble, basic colors, or unique designs on a decorative, protective, and water-proof pressure sensitive sheet (PSS). Also, the decorative and protective covering process and system can produce a unique covering for almost all parts of a kitchen or bath. It can be applied to cabinets, countertops, backsplashes, refrigerators, dishwashers, shower surrounds, walls, doors, floors, furniture and more. Custom designs, patterns, and color matching are also readily produced by the improved decorative and protective covering process and system to meet specific needs of customers.

The improved decorative and protective covering process and system are: easy to install or repair; makes almost any surface look new again; looks like the real thing; durable; protects surfaces; water-proof; heat-resistant; dramatically reduces weight; significant installed costs savings; little mess; and can have a high gloss or matte finish.

The improved decorative and protective covering process and system can be used for: backsplashes or shower surrounds; marble, granite, stone, wood, or unique countertops; covering cabinets instead of re-finishing, re-facing, or painting; and giving refrigerators and dishwashers the look of stainless steel or other material and colors.

An entire kitchen can be transformed in substantially less time and at a fraction of the cost than conventional renovations by the improved decorative and protective covering process and system. Also, the improved decorative and protective covering process and system allows for an attractive and classy look of real tile or custom surfaces while significantly cutting the installation and maintenance time. High definition, photo-quality colors and custom designs are easy with the novel decorative and protective covering process and system. It can be removed easily, which allows for future flexibility.

The improved decorative and protective covering process and system can wrap various items in kitchen or almost any surface with a thin protective and decorative covering. Using a pressure sensitive sheet known as PSS, the improved decorative and protective covering process and system can cover cabinets, countertops, tile, stone, or almost any flat surface with a high definition picture of tile, stone, wood, unique colors and/or designs.

The improved decorative and protective covering process and system is particularly useful for commercial apartment rentals either by monthly turns or rehabs, rental condominiums, nursing homes, or for builders. The improved decorative and protective covering process and system provides a new application for interior and exterior surfaces.

The improved decorative and protective covering process and system can further include printing of designs on materials targeted for corporate entities that focus on constructing or remodeling large apartment buildings as well as can be used by others.

The improved decorative and protective covering process and system achieves a major competitive advantage in regards to price and ease of installation while maintaining aesthetics. Customers will gain many advantages.

The improved decorative and protective covering process and system is useful for retrofitting any space that needs improvement with a quick, easy, no-mess, attractive, and cost-effective results. It can actually improve the look of almost any space for substantially less money.

The improved decorative and protective covering process and system is particularly useful in: apartments, restaurants, hospitals, nursing homes, single family homes, condominiums, town homes, pre-manufactured homes, mobile homes, RVs, hotels, motels, studio sets, theaters, gas grills, outdoors applications, furniture, and other applications.

The primary target markets of the improved decorative and protective covering process and system can be rental apartment and condominium owners, apartment management groups, and apartment associations due to a higher payback with volume.

Other uses for the improved decorative and protective covering process and system can include: various tile applications, including but not limited to, backsplashes and showers, kitchens, bathrooms, utility rooms, bars, wet bars, basements, laundry rooms, entry ways, gazebos, outdoor bars, outdoor grilling areas, studio sets, theaters, furniture, tables, walls, doors, floors, garages, entry ways, and offices.

Other advantages are: (1) weight reduction to reduce fuel consumption, (2) decreased turnaround time to re-rent an apartment, (3) better economics of reducing cost, (4) heat-resistant for countertops, etc.

For apartments, the improved decorative and protective covering process and system can provide a more affordable and attractive a backsplash in the rental unit; allow a rental to be renovated and be rented again in a day by decreasing tiling delays; cover blemishes cost effectively which can postpone big repairs for years; improve rental rates with a more beautiful look created in the rental units; eliminate some third party contractors; re-wallpaper a wall in the same day; reduce long term cost of ownership; decrease time to market by 90% and reduce installed costs by 75%.

For restaurants, the improved decorative and protective covering process and system can redo a restaurant image at a fraction of the cost and time as well as improve the look of any fake surface or real surface.

For hospitals and nursing homes, the improved decorative and protective covering process and system can redo a hospital or nursing home room image at a fraction of the cost and time, as well as improve the look of any fake surface or real surface in hallways, waiting rooms, day rooms, nurses' stations, etc. and protect surfaces from wear.

For single family homes, condominiums and town homes, the improved decorative and protective covering process and system can redo your personal space at a fraction of the cost and time, as well as improve the look of any fake surface or real surface.

For pre-manufactured homes, mobile homes and recreational vehicles (RVs), the improved decorative and protective covering process and system can reduce weight, improve fuel consumption and give the look of real tile, stone, wood or other material.

For hotels and motels, the improved decorative and protective covering process and system can cover blemishes without renovating an entire tile or wall area; improve the look of a kitchen, bath, counter, or furniture surface without replacement and give the look of real tile.

For studio sets and theaters, the improved decorative and protective covering process system can reduce weight and decrease the runaround or change-over between scenes and sets.

For gas grills, outdoors applications, furniture and other applications, the improved decorative and protective covering process and system can provide a product that looks like real tile or stone and is light weight and water-proof.

The improved decorative and protective covering process can comprise producing a multiple layered (multi-layer) laminated protective decorative cover by processing an electronic image in a central processing unit (CPU) to form a processed image; printing the processed image on media to form a printed media; heating and drying the printed media; and laminating the dried printed media to form a multiple layered laminated protective decorative cover. The improved decorative and protective covering process can further comprise decorating and protecting a product by installing and applying the multiple layered laminated protective decorative cover to a surface of the product, other than, in the absence of and excluding a cooler and an outside exterior surface of a mode of transportation, such as a racecar, truck, bus, vehicle, train or boat.

In one preferred method, the multiple layered laminated protective decorative cover can be installed and applied to the surface of the product by first preparing the surface of the product by removing from the surface any fixtures, handles, outlet cover or detachable external parts; aligning and positioning the multiple layered laminated protective decorative cover on the surface; detachably taping the multiple layered laminated protective decorative cover to the surface; fractionating the multiple layered laminated protective decorative cover to form a temporary hinge with the tape; peeling and removing part of the backer in proximity to the hinge to expose part of the adhesive layer; severing and exposing the removed part of the backer; pressing, flattening and securing the exposed part of the adhesive layer of the multiple layered laminated protective decorative cover against the surface of the product by firmly wiping the laminated layer with back and forth movements of a squeegee; removing the tape and hinge; peeling and removing another part of the backer to expose another part of the adhesive layer; severing and exposing the removed other part of the backer; and pressing, flattening and securing the other exposed part of the adhesive layer of the multiple layered laminated protective decorative cover against the surface of the product by firmly wiping the laminated layer with back and forth movements of the squeegee.

The improved decorative and protective covering process can also include the following before processing the electronic image in the CPU to form the processed image: photographing items, such as tiles, stone, granite, marble, grout, and/or wood, to produce a decorative photographic image comprising an electronic photographic image or a photographic print; scanning any photographic print resulting from the photographing to form a scanned electronic image; and downloading the electronic photographic image or scanned electronic image into the CPU. The image is then processed in the CPU for: color management, color enhancement, color correction, color profiles, replication, creating a seamless pattern, and/or color replacement.

The surface of the product can be further prepared by: degreasing the surface; wiping the surface with alcohol, such as isopropyl alcohol; coating the surface with a primer; and/or applying an adhesive promoter to the surface. Desirably, air bubbles from the multiple layered laminated protective decorative cover can be vented and released, and excess portions of the multiple layered laminated protective decorative cover which extend over the edges of the product can be trimmed. The multiple layered laminated protective decorative cover can be heated to further securely bond the multiple layered laminated protective decorative cover against the surface of the product.

The improved decorative and protective covering system can be a composite assembly comprising a product having at least one surface, other than, in the absence of and excluding a cooler and an outside exterior surface of a mode of transportation, such as a racecar truck, bus, vehicle, train or boat. The composite assembly can further comprise: a multiple layered (multi-layer) laminated protective decorative cover providing a wrap which can be securely bonded to, cover and protect the surface of the product. The multiple layered laminated protective decorative cover can comprise: an outer transparent laminated layer; an intermediate decorative layer comprising printed media with a front decorative surface and a back surface; an adhesive layer comprising adhesive portions on the back surface of the printed media; and an inner removable backing layer providing a backer. The media can comprise a pressure sensitive sheet.

The printed media can comprise one or more images of: tile, stone, marble, granite, grout, wood, a solid color, metallic color, stainless steel, pattern, text, words, numbers, alpha numeric images, characters, symbols, logos, designs, colored indicia, black indicia, graphics, picture, design, decorative image, or combinations of any of the preceding.

The product can comprise: a door, wall, cabinet, countertop, table, backsplash, wall tile, shower surround, refrigerator, dishwasher, gas grill, furniture, air conditioner, elevator, garage door, floor, ceiling, toilet, window sill, window frame, door frame, or combinations of any of the preceding.

Advantageously, the product can be used and located in an area, such as a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured home, apartment, restaurant, house, home, hotel, motel, hospital, nursing home, mobile home, interior of recreational vehicle (RV), trailer, interior of boat, interior of train, interior of bus, rehabs, rental unit, condominium, single family home, town home, gazebo, porch, outdoor bar, grilling area, an interior inside surface, or combinations of any of the preceding.

A more detailed explanation of the invention is provided in the following detailed descriptions and appended claims taken in conjunction with the accompanying drawings.

### BRIEF DESCRIPTION OF THE DRAWINGS

FIGS. 1-3 illustrate various steps of a design process of a decorative and protective covering process and system in accordance with principles of the present invention.

FIG. 4 illustrates various steps of a print process of a decorative and protective covering process and system in accordance with principles of the present invention.

FIGS. 5-13 illustrate various steps of an installation process of a decorative and protective covering process and system in accordance with principles of the present invention.

FIG. 14 illustrates a refrigerator, cabinets and backsplash before the laminated decorative protective covers were installed.

FIG. 15 illustrates a refrigerator, cabinets and backsplash after the laminated decorative protective covers were installed.

FIG. 16 is a perspective view of a table with a laminated protective decorative cover in a recreational vehicle (RV) or motor home.

FIG. 17 is an enlarged perspective view of a multi-layer laminated protective decorative cover of a decorative and protective covering process and system in accordance with principles of the present invention.

### DETAILED DESCRIPTION OF THE INVENTION

The following is a detailed description and explanation of the preferred embodiments of the invention and best modes for practicing the invention.

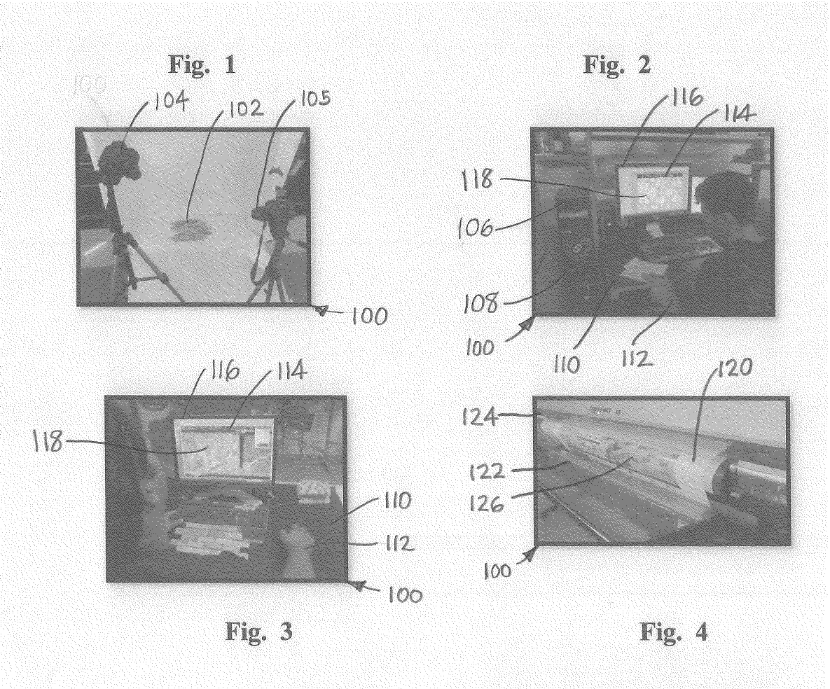

The decorative and protective covering process and system 100 (FIG. 1) can include: (1) a design processor or subprocess; (2) print process and (3) installation process or subprocess.

The design process can include photographing and/or scanning one or more items 102. The initial imaging of the items(s), such as a tile, stone, or granite, can be performed by digital photograph with a 12 megapixels or higher camera 104 or 105 and/or by scanning with a scanner having a minimum setting of 600 dpi (dots per square inch) to preserve detail. Solid colors used on final product need not be photographed or scanned. A photograph of tile or stone can be done individually or in a preset pattern. Often, very small tile is on a 12 inch by 12 inch mesh. The digital image can be then transferred from a camera memory card to the hard drive 106 of a central processing unit (CPU) 108 (FIG. 2), such as a computer. The individual tile or mesh of smaller tile can be scanned by high quality scanner at a setting of 600 dpi directly onto the hard drive of the CPU. A 600 dpi is an excellent setting to preserve detail of each item. Photographs of granite or marble can be done in a larger setting as larger surface areas of the items are needed to produce a quality final print. Approximately 12 feet by 6 feet photograph of granite or marble can be taken. The digital image can be transferred to the hard drive of computer. Solid colors for prints are preferably not photographed or scanned but produced with computer graphics in the CPU.

The scanned and or photographed image can then be imported and transferred to a design station 110 (FIG. 3). At the design station, a designer 112 can digitally replicate the item, e.g. a tile to match the imported image on the display screen 114 of a monitor 116 of the CPU. Color corrections, grout, backgrounds can then electronically added to enhance the final image 118. Then designer can electronically set up a seamless pattern in the image on the display screen to match panel to panel. Thereafter, the designer can save the completed pattern and final image for print.

In the print process or subprocess, the image can be electronically downloaded and imported into color management software of the CPU. The image can be then sent to raster image processing (RIP) software for the first test print. The test print is preferably done with the original, uncorrected file, in order to determine color corrections needed. The designer and/or CPU can analyze the print and electronically make necessary corrections to file, color profiles, color corrections, and/or color replacements. The image is then sent to the RIP again and test printed. The print process is repeated until the print matches the original tile or other item. Once approved, the file is sent for the final RIP and prepared for the final print. In printing of the final image, media 120 (FIG. 4) is loaded on printer 122 and the post heaters 124 are turned on. The image can be electronically transferred and sent to printer to form an inked decorative image 126 of the printed media to produce a final print. Once dry, the printed media can be sent to a laminator for a protective laminate for the printed media. When complete, the final multi-layer laminated protective decorative cover can be trimmed and packaged for shipment.

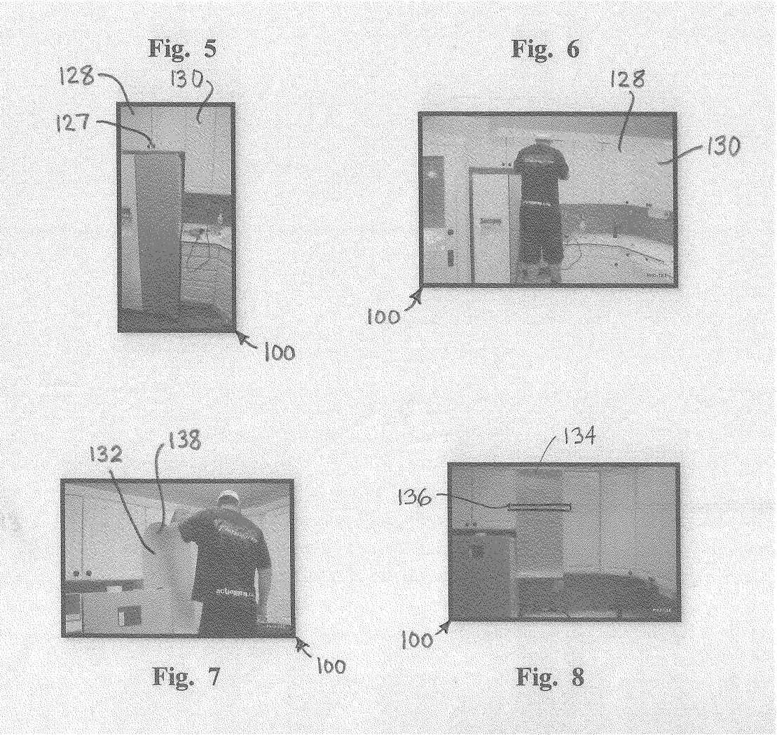

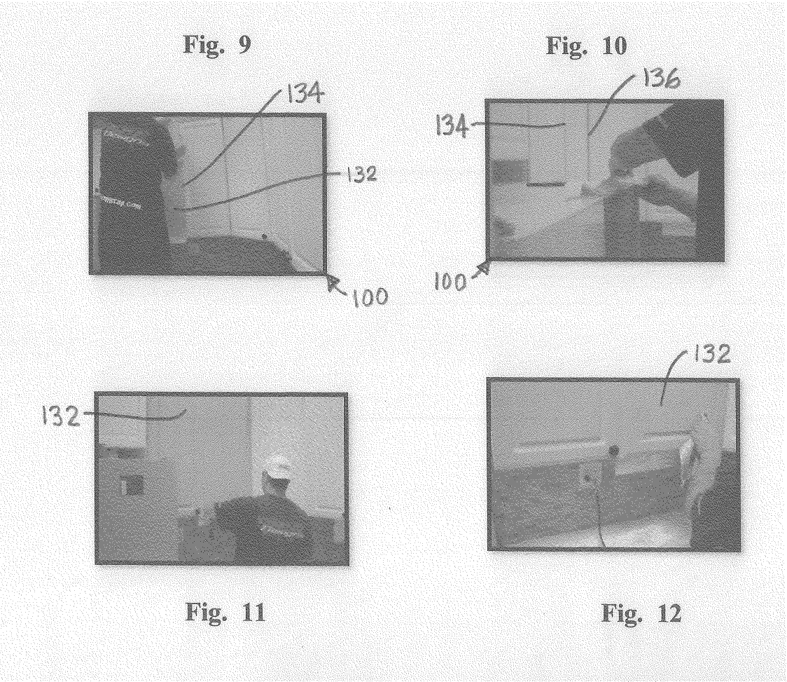

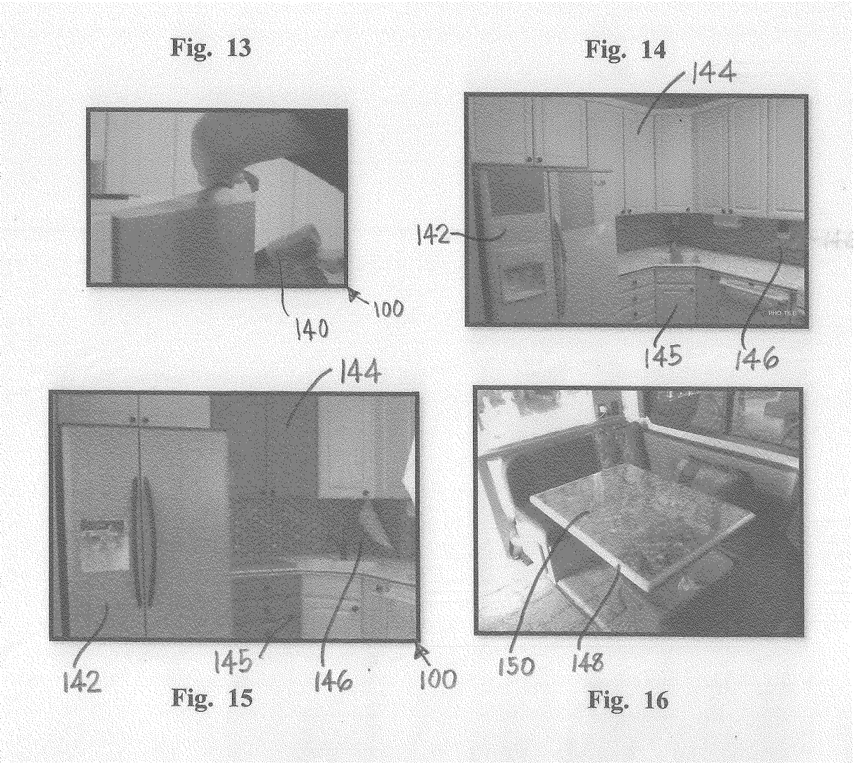

The installation process or subprocess preferably includes surface preparation in which all fixtures 127 (FIG. 5), such as handles, parts, outlet covers and hardware are removed from the surface 128 (FIGS. 5 and 6) of the product 130 to be covered, protected and wrapped. The surface of the product can be degreased and wiped with alcohol, such as isopropyl alcohol, and an adhesive promoter can be applied in necessary locations to ensure proper adhesion and installation. The installation process or subprocess also includes installation of the media and laminated cover on the surface of the product. This can be accomplished by first aligning the multiple layered (multi-layer) laminated protective decorative cover 132 (FIG. 7) with the printed media in a proper location and applying masking tape 134 (FIG. 8) to hold the cover in place. Masking tape can then be applied across the center of the cover to create a hinge 136 (FIG. 8). The tape can be removed from one side of the cover and pulled past the hinge and the paper backer 138 (FIG. 7) and peeled up to hinge, exposing the adhesive side of the printed media of the decorative cover. As shown in FIG. 9, the paper backer can be severed (cut) right before the hinge and the media of the covers are pulled back to the original spot so that the adhesive is facing the surface such that the media of the cover lays flat on the surface of the product. The laminated protective decorative cover can then be mounted and securely pressed against the surface of the product by using a squeegee from the hinge, going side to side from the center out. Occasional lifting of the cover may be required in order to keep the cover flat. After the first half is complete, the installer can remove the rest of tape as shown in FIG. 10 including the hinge 136. The installer can then fold over the other half of uninstalled cover and repeat the preceding steps of the installation process, squeegeeing from the center out until the entire cover is securely mounted and installed on the surface of the product. Thereafter, the installer can trim any excess cover off and from openings as shown in FIGS. 10 and 11, etc. using a cutter, such as a single edge razor blade, knife or scissors. The cover should be checked for any excess air or bubbles left in media. The media comprising the pressure sensitive sheet can have air relief adhesive and can release air when pressed. The installer can post heat the cover with heat from a heater 140 (FIG. 13) to ensure proper bond between the cover and the surface of the product. Fixtures such as handles, knobs, hardware and outlet covers can be reinstalled and/or transferred to the covered product.

FIG. 14 illustrated a refrigerator 142, cabinets 144 and 145 and backsplash 146 before the laminated protective decorative covers were installed. FIG. 15 illustrates the refrigerator, cabinets and backsplash after the laminated protective decorative covers were installed.

FIG. 16 illustrative a table 148 with a laminated protective decorative covers 150 in a recreational vehicle (RV) or mobile home.

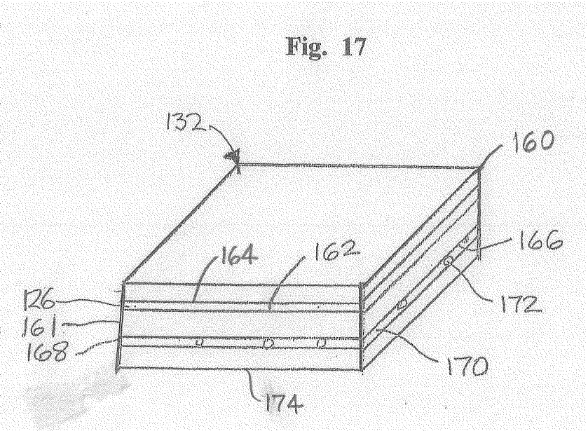

The multiple layered (multi-layered decorative cover 132 (FIG. 17) can comprise: an outer transparent laminated layer 160; an intermediate decorative layer 161 comprising printed media on a pressure sensitive sheet (PSS) with a front decorative surface 162, having one or more images 164 thereon and a back surface 166; an adhesive layer 168 comprising adhesive portions 170 and air relief passageways 172 providing vents for egress, release and discharge of air bubbles, and an inner removable backing layer 174 providing a pressure sensitive sheet (PSS) backer comprising a paper liner. The laminated transparent layer can be applied with a laminator machine after the printing process. All covers can have this layer, except the stainless look refrigerator and dishwasher. The image shows where the ink goes and to clarify that the there is design work that goes into the product. The ink gets applied on the pressure sensitive sheet (PSS) comprising the media. All covers can have an ink image, except the stainless look refrigerator and dishwasher. The paper liner can be white and together with the PSS is sometimes referred to as a base sheet. The PSS backer, also known as the paper liner, is the layer that gets removed during installation to reveal the adhesive on the back side (surface) of the PSS.

The pressure sensitive sheet (PSS), media or base sheet can comprise a composite material or film such as available from 3M under the brand name or product number 180 #1J180CV3, 380 #1J380CV3 or #1080 for refrigerator or dishwashers; or Arlon under the brand name or product number #6000 X or #6000 XRP.

The laminate can comprise a laminate sheet, such as available from: 3 M under the brand name or product number #8515 or #8580; or Arlon under the brand name or product number #3200.

The ink for the printed media can comprise an organic ink, such as available from Mimaki under the brand name or product number #SS2 SPC-0380 Y-A, #SS2 SPC-0380 M-A, #SS2 SPC-0380 C-A, or #SS2 SPC-0380 K-A. Generally, media, pressure sensitive sheets (PSS) and wraps are printed using solvent inks rather than ultraviolet (UV) inks. That's because solvent inks offer greater flexibility and conformability over vehicle curves. Some of the reasons to use graphics printed with solvent inks versus UV inks are: UV inks require greater pressure needed to squeegee out air through channels; UV inks are more brittle during application especially in cooler temperatures; solvent inks stretch more readily allowing easier application over heavily contoured areas; and solvent printers usually have a lower initial cost.

The following examples illustrate comparison and tests of laminated protective decorative covers produced according to the inventive process and system. These examples shall not be regarding as restricting the scope of the invention, as they are only some examples of the inventive laminated protective decorative covers.

### Example 1

### Comparison of Costs and Time for Backsplash

A small back splash was formed by tiling two walls of an “L” shaped kitchen where the first wall was 1.5° high by 12′ long and the second wall was 1.5′ high by 7′ long for a total of 28.5 square feet. The material costs for the conventional tiled backsplash was $596. The installation time for the conventional timed back splash took 4.5 days. A laminated protective decorative cover comprising images of the tiled back splash was produced according to the inventive process at a cost $157 and was installed in 0.46 days for a savings of $439 or a 75% cost reduction and a 90% time reduction.

### Example 2

### Comparison of Costs and Time for a Shower

A small shower was constructed by tiling three walls of a “C” shaped shower where the first wall was 5′ high by 30″ long, the second wall was 5′ high by 5′ long, and the third wall is 5′ high by 30″ for a total of 50.0 square feet. The material costs for the conventional tiled shower surround was $821 and it was installed in 5.5 days. A laminated protective decorative cover comprising images of the tiled shower surround was produced according to the inventive process at a cost of $200 and installed in 0.55 days for a savings of $621 or a 75% cost reduction and a 90% time reduction.

### Example 3

### Backsplash Test #1

A laminated protective decorative cover for a backsplash was produced according to the inventive process and system and comprised a pressure sensitive sheet (PSS) of polyvinyl chloride (PVC) matte white and was installed over a glass backsplash. The wall sockets were cut out and 90 degree angles were used to continue down the L-shaped wall. It looked and performed well in an actively used kitchen.

### Example 4

### Backsplash Test #2

A laminated protective decorated cover for a backsplash was produced according to the inventive process and system and comprised a pressure sensitive sheet (PSS) of Arlon DPF 6000X over a glass backsplash. The wall sockets were cut out and 90 degree angles were used to continue down the L-shaped wall, it looked and performed well in an actively used kitchen.

### Example 5

### Backsplash Test #3

A laminated protective decorative cover for a backsplash was for a produced according to the inventive process and system and comprised a pressure sensitive sheet (PSS) of Arlon DPF 6000X over itself multiple times in a couple hours to show the ease of installation and various patterns.

### Example 6

### Inset Cabinet Test #1

A laminated protective decorated cover for a cabinet that was produced according to the inventive process and system and comprised a pressure sensitive sheet (PSS) of Arlon 6000X with an Arlon 3200 laminate. This was more difficult to apply on a non-flat surface, took more time, and rewired a heat gun. After 2-3 days in an active kitchen it started to bubble at the inset.

### Example 7

### Inset Cabinet Test #2

A laminated protective decorative cover for a cabinet was produced according to the inventive process and system and comprised a pressure sensitive sheet (PSS) of 3M 180 with 3M 8580 laminate on same door front. Use more heat to help the install. After 2-3 days in an active kitchen it started to bubble at the inset similar to test #1.

### Example 8

### Inset Cabinet Test #3

Performed the same steps as Example 7 Test #2 but used 3M primer. After 4-5 days in an active kitchen, it started to bubble at the inset again.

### Example 9

### Inset Cabinet Test #4

A laminated protective decorated cover for a cabinet produced according to the inventive process and system and comprised a pressure sensitive sheet (PSS) of 3 M 380 products with 8515 laminate and primer on the same cabinet door. After 4-5 days in an active kitchen, it started to bubble at the inset again. Note that the previous covering was always removed in the cabinet testing.

### Example 10

### Inset Cabinet Test #5

A laminated protective decorated cover for a cabinet produced according to the inventive process and system and comprised a pressure sensitive sheet (PSS) of 3M 380 base sheet with 8580 laminate and primer and heat. It was easier to install than past tests. This seems to be the answer as it has held up for weeks.

### Example 11

### Countertop Test #1

A laminated protective decorated cover for a countertop produced according to the inventive process and system and comprised a pressure sensitive sheet (PSS) of Arlon DPF 6000X with a matte finish laminate. Boiled water in a large sauce pot for 30 minutes then moved it to the countertop instantly and let it set for three minutes. After removal, there was zero discoloration or warping of the covering. It looked like it had prior to the test boiling water (heat).

### Example 12

### Countertop Test #2

Use the prior Arlon DPF 6000X with a matte finish laminate install. Re-perform Example 11 on the same spot except with sauce instead of water. After removal, there was zero discoloration or warping of the covering. It looked like it had prior to the sauce test.

### Example 13

### Countertop Test #3

Use a knife to cut the original Test #1 installation of the countertop Example 11. The knife did cut the covering like it would a particle board countertop. The cuts did not peel or rip. The product with cuts held up very well.

### Example 14

### Countertop Tests #4

Use a knife to cut onions with water on the installation of the countertop of Example 11. The covering held up like very well.

### Example 15

### Countertop Tests #5-10

Use six different cleaners the harshest that could be found to clean the surface with heavy scrubbing on the installation of the countertop of Example 11. There was zero discoloration, loss of covering, or loss of color. The product held up incredibly well even when cleaners were allowed to sit for 30 minutes each often on the same spot.

### Example 16

### Refrigerator Test #1

Cover a white refrigerator with 3M cast vinyl brushed aluminum using a heat gun. No laminate is required. The covering looks great and has held up for over a month with no problems.

### Example 17

### Tile Shower Surround Test #1

A laminated protective decorated cover for a shower surround produced according to the inventive process and system and comprised a pressure sensitive sheet (PSS) of Arlon 6000 XRP with 3M 8515 laminate in part of an actively used shower, with zero peeling.

### Example 18

### Tile Shower Surround Test #2

A laminated protective decorated cover for a shower surround produced according to the inventive process and system and comprised a pressure sensitive sheet (PSS) of Arlon 6000 XRP with 3M 8580 laminate in part of an actively used shower, with zero peeling after a month.

### Example 19

### Tile Shower Surround Test #3

A laminated protective decorated cover for a shower surround produced according to the inventive process and system and comprised a pressure sensitive sheet (PSS) of Arlon 6000X with 3M 8515 laminate in part of an actively used shower, with zero peeling after a month.

### Example 20

### Tile Shower Surround Test #4

A laminated protective decorated cover for a shower surround produced according to the inventive process and system and comprised a pressure sensitive sheet (PSS) of Arlon 6000X with 3M 8580 laminate in part of an actively used shower, with zero peeling after a month.

### Example 21

### Tile Shower Surround Test #5

A laminated protective decorated cover for a shower surround produced according to the inventive process and system and comprised a pressure sensitive sheet (PSS) of 3M 180 with 3M 8515 laminate in part of an actively used shower, with zero peeling after a month.

### Example 22

### Tile Shower Surround Test #6

A laminated protective decorated cover for a shower surround produced according to the inventive process and system and comprised a pressure sensitive sheet (PSS) of 3M 380 XRP with 3M 8580 laminate in part of an actively used shower, with zero peeling after a month.

### Example 23

### Tile Shower Surround Test #7

A laminated protective decorated cover for a shower surround produced according to the inventive process and system and comprised a pressure sensitive sheet (PSS) of Arlon 6000 XRP with 3M 8515 laminate in part of an actively used shower on a tiled window edge where some of the tile is cracked and the grout is gone, with zero peeling after a month.

### Example 24

### RV Table Test #1

A laminated protective decorated cover for a table produced according to the inventive process and system and comprised a pressure sensitive sheet (PSS) of Arlon 6000 XRP with 3M 8515 laminate on the kitchen table in an RV to cover a Corian-looking color on a particle board table. The marble top looks like the real thing and has not discolored or peeled after a month.

Laminate on the printed media provides protection against abrasion, grime and moisture. A UV protection laminate will help protect the printed graphics against fading and deterioration. The laminate also enhances the finish of the graphics. Gloss, matte and luster finishes are just a few options. A gloss laminate can help increase the vibrancy of the colors in the print. Some matte or luster finish laminates will help create a glare-free finish.

For metallic or solid colors, the pressure sensitive sheet can comprise a film, such as available for 3M under the brand name or product number Scotchcal Wrap film, Series 1080. These films do not require printing or lamination and are made with two layers of color for extra durability. There are matte colors, carbon fiber options and brushed metal colors available. This ready-to-go material adds unique color and textures to full and partial product wraps. The film is repositionable until firm pressure is applied. Non-visible air release channels also make this film easy to apply without bubbles.

The pressure sensitive sheet can also comprise a calendared vinyl film with gloss calendared overlaminate, such as available from Arlon under the brand name or product number 3420. Calendared vinyl film also has venting technology that helps release air bubbles.

Allow sufficient time between printing and lamination for the printed graphics to fully dry. Try to create a clean dust-free environment for laminating printed graphics. Use foam squeegees when applying unmasked laminated graphics to avoid scratching the finish of the film.

As previously described, the improved decorative and protective covering process can comprise producing a multiple layered (multi-layer) laminated protective decorative cover by first photographing items, such as tiles, stone, granite, marble, grout, and/or wood, to produce a decorative photographic image comprising an electronic photographic image or a photographic print; scanning any photographic print resulting from the photographing to form a scanned electronic image; and downloading the electronic photographic image or scanned electronic image into the CPU. Thereafter, the electronic image can be processed in a central processing unit (CPU) at a design station with raster image processing (RIP), such as for color management, color enhancement, color correction, color profiles, replication, creating a seamless pattern, and/or color replacement, so as to form a processed image. The processed image can be printed on media to form a printed media and the printed media can be heated and dried. Thereafter, the dried image can be laminating to form a multiple layered laminated protective decorative cover.

The CPU can be: a computer, laptop computer, desktop computer, portable computer, personal computer, microprocessor, computer system, tablet computer, wireless computer, wired computer; netbook, electronic communications device, portable networking device, a radiotelephone, a cellular (cell) phone, a mobile phone, smart phone, flip phone, slider phone, android phone, tablet phone, camera phone, clamshell device, portable networking device, qwerty flip device, wireless device, portable mobile communications device, personal digital assistant (PDA), wireless e-mail device, internet communication device, android phone, ipod, ipad, blackberry, tablet device, hand held electronic device, mobile electronic device, or combinations of any of the preceding.

The multiple layered laminated protective decorative cover can be installed and applied to a surface, such as an exterior or interior surface of a product, to decorate and protect the product. However, such surface does not include a cooler or the outside exterior surface of a mode of transportation, such as a racecar, truck, bus, vehicle, train or boat. Preferably, the multiple layered laminated protective decorative cover can be installed and applied to the surface of the product by first preparing the surface of the product by removing from the surface any fixtures, handles, outlet cover or detachable external parts; degreasing the surface; wiping the surface with alcohol, such as isopropyl alcohol; coating the surface with a primer; and/or applying an adhesive promoter to the surface. Thereafter, the multiple layered laminated protective decorative cover can be aligned, positioned and/or detachably taped to the surface with masking tape or other tape; fractionating the multiple layered laminated protective decorative cover to form a temporary hinge with the tape; peeling and removing part of the backer in proximity to the hinge to expose part of the adhesive layer; severing (cutting) and disposing the removed part of the backer; pressing, flattening and securing the exposed part of the adhesive layer of the multiple layered laminated protective decorative cover against the surface of the product by firmly wiping the laminated layer with back and forth movements of a squeegee; removing the tape and hinge; peeling and removing another part of the backer to expose another part of the adhesive layer; severing and disposing the removed other part of the backer; and pressing, flattening and securing the other exposed part of the adhesive layer of the multiple layered laminated protective decorative cover against the surface of the product by firmly wiping the laminated layer with back and forth movements of the squeegee. Desirably, air bubbles, in the multiple layered laminated protective decorative cover can be vented and released concurrently or simultaneously with the squeegeeing. The multiple layered laminated protective decorative cover can be heated to further securely bond the multiple layered laminated protective decorative cover against the surface of the product. Excess portions of the multiple layered laminated protective decorative cover which extend over the edges of the product can be trimmed.

The improved decorative and protective covering system can be a composite assembly comprising a product having at least one surface, other than, in the absence of and excluding a cooler and an outside exterior surface of a mode of transportation; such as a racecar, truck, bus, vehicle, train and boat. The composite assembly can further comprise a multiple layered (multi-layer) laminated protective decorative cover providing a wrap which can be securely bonded to, cover and protect the surface of the product. The multiple layered laminated protective decorative cover can comprise: an outer transparent laminated layer; an intermediate decorative layer comprising printed media with a front decorative surface and a back surface; an adhesive layer comprising adhesive portions on the back surface of the printed media; and an inner removable backing layer providing a backer. The media can comprise a pressure sensitive sheet.

The printed media can comprise one or more images of: tile, stone, marble, granite, grout, wood, a solid color, metallic color, stainless steel, a pattern, text, words, numbers, alpha numeric images, characters, symbols, logos, designs, colored indicia, black indicia, graphics, picture, design, decorative image, or combinations of any of the preceding.

The product can comprise: a door, wall, cabinet, countertop, table, backsplash, wall tile, shower surround, refrigerator, dishwasher, gas grill, furniture, air conditioner, elevator, garage door, floor, ceiling, toilet, window sill, window frame, door frame, shelf or combinations of any of the preceding.

Advantageously, the product can be used and located in an area, such as: a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured homes, apartment, restaurant, house, home, hotel, motel, hospital, nursing home, mobile home, interior of recreational vehicle (RV), trailer, interior of boat, interior of train, interior of bus, rehabs, rental unit, condominium, single family home, town home, gazebo, porch, outdoor bar, grilling area, an interior inside surface, or combinations of any of the preceding.

Some of the advantages and benefits of the multi-layer laminated protective decorative cover are:

(a) Stretch it.

(b) Stick it.

(c) Highly conformable cast film

(d) Graphics resist lifting.

(e) Primer or relief cuts not usually needed.

(f) Fast installation.

(g) Slideable & repositionable.

(h) Good snap-up.

(i) Useful air release technology.

(j) Smooth appearance.

(k) Removes cleanly with heat.

Among the many advantages of the improved decorative and protective covering process and system are:

1. Superior product.

2. Outstanding performance.

3. Quicker turnaround and faster installation.

4. Excellent alternative to costly remodeling and construction.

5. Significant installed cost savings.

6. Decreased maintenance and repair.

7. User and customer friendly.

8. Make a surface look better.

9. Light weight.

10. Protects surfaces.

11. Heat resistant.

12. Waterproof.

13. Durable.

14. Superb quality.

15. Better wear.

16. Efficient.

17. Classy.

18. Attractive.

19. Efficient.

20. Economical.

Although embodiments and examples of the invention have been shown and described, it is to be understood that various modifications, substitutions, and rearrangements of parts, components, and/or process (method) steps, as well as other uses, shapes, construction, and design of the inventive decorative and protective covering process and system can be made by those skilled in the art without departing from the novel spirit and scope of this invention.

What is claimed is:

1. A decorative and protective covering process, comprising the steps of:
producing a multiple layered (multi-layer) laminated protective decorative cover by processing an electronic image in a central processing unit (CPU) to form a processed image;
printing the processed image on media to form a printed media;
heating and drying the printed media;
laminating the dried printed media to form a multiple layered laminated protective decorative cover;
said multiple layered laminated protective decorative cover comprising;
an outer transparent laminated layer;
an intermediate decorative layer comprising said printed media, said intermediate decorative layer having a front decorative surface and a back surface; and said media comprising a pressure sensitive sheet;
an adhesive layer comprising adhesive portions on the back surface of said printed media;
an inner removable backing layer providing a backer;
protecting and decorating a product including installing and applying the multiple layered laminated protective decorative cover to a surface of the product, other than, in the absence of and excluding a cooler and an outside exterior surface of a mode of transportation selected from the group consisting of a racecar, truck, bus, vehicle, train and boat, by preparing the surface of the product by removing from the surface any fixtures, handles, outlet cover or detachable external parts;
aligning and positioning the multiple layered laminated protective decorative cover on the surface;
detachably taping the multiple layered laminated protective decorative cover to the surface;
fractionating the multiple layered laminated protective decorative cover to form a temporary hinge with said tape;
peeling and removing part of the backer in proximity to the hinge to expose part of the adhesive layer;
severing and disposing the removed part of the backer;
pressing, flattening and securing the exposed part of the adhesive layer of the multiple layered laminated protective decorative cover against the surface of the product by firmly wiping the laminated layer with back and forth movements of a squeegee;
removing the tape and hinge;
peeling and removing another part of the backer to expose another part of the adhesive layer;
severing and disposing the removed other part of the backer; and
pressing, flattening and securing the other exposed part of the adhesive layer of the multiple layered laminated protective decorative cover against the surface of the product by firmly wiping the laminated layer with back and forth movements of the squeegee.

2. A decorative and protective covering process in accordance with claim 1 comprising:
photographing items to produce a decorative photographic image selected from the group consisting of an electronic photographic image and a photographic print;
scanning any photographic print resulting from said photographing to form a scanned electronic image;
downloading the electronic photographic image or scanned electronic image into the CPU; and
said items are selected from the group consisting of tiles, stone, granite, marble, grout, wood and combinations thereof.

3. A decorative and protective covering process in accordance with claim 1 wherein said processing of said electronic image in said CPU is selected from the group consisting of: color management, color enhancement, color correction, color profiles, replication, creating a seamless pattern, color replacement, and combinations of the preceding.

4. A decorative and protective covering process in accordance with claim 1 including:
trimming the multiple layered laminated protective decorative cover; and
shipping the trimmed multiple layered laminated protective decorative cover.

5. A decorative and protective covering process in accordance with claim 1 wherein said preparing the surface includes one or more of the following:
degreasing the surface;
wiping the surface with alcohol;
coating the surface with a primer; and
applying an adhesive promoter, the surface.

6. A decorative and protective covering process in accordance with claim 1 wherein said protecting and decorating a product includes:
trimming excess portions the multiple layered laminated protective decorative covet tending over the edges of the product;
venting air bubbles from the multiple layered laminated protective decorative cover; and
heating the multiple layered laminated protective decorative cover securely against the surface of the product.

7. A decorative and protective covering process in accordance with claim 1 wherein said CPU is selected from the group consisting of: a computer, laptop computer, desktop computer, portable computer, personal computer, microprocessor, computer system, tablet computer, wireless computer, wired computer; netbook, electronic communications device, portable networking device, a radiotelephone, a cellular (cell) phone, a mobile phone, smart phone, flip phone, slider phone, android phone, tablet phone, camera phone, clamshell device, portable networking device, qwerty flip device, wireless device, portable mobile communications device, personal digital assistant (PDA), wireless e-mail device, internet communication device, android tablet, ipod, ipad, blackberry, tablet device, hand held electronic device, mobile electronic device, and combinations of any of the preceding.

8. A decorative and protective covering process in accordance with claim 1 wherein said product is selected from the group consisting of: a door, wall, cabinet, countertop, table, backsplash, wall tile, shower surround, refrigerator, dishwasher, gas grill, furniture, air conditioner, elevator, garage door, floor, ceiling, toilet, window sill, window frame, door frame, shelf, and combinations of any of the preceding.

9. A decorative and protective covering process in accordance with claim 1 wherein said product is used and located in an area selected from the group consisting of: a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured homes, apartment, restaurant, house, home, hotel, motel, hospital, nursing home, mobile home, interior of recreational vehicle (RV), interior of trailer, interior of boat, interior of train, interior of bus, rehabs, rental unit, condominium, single family home, town home, gazebo, porch, outdoor bar, grilling area, an interior inside surface, and combinations of any of the preceding.

10. A decorative and protective covering process in accordance with claim 1 wherein said image is selected from the group consisting of: tile, stone, marble, granite, grout, wood, a solid color, metallic color, stainless steel, a pattern, text, words, numbers, alpha numeric images, characters, symbols, logos, designs, colored indicia, black indicia, graphics, picture, design, decorative image and combinations of any of the preceding.

11. A decorative and protective covering process, comprising the steps of:
photographing one or more items to produce a decorative photographic image selected from the group consisting of an electronic photographic image and a photographic print;
scanning any photographic print resulting from said photographing to form a scanned electronic image;
downloading the electronic photographic image or scanned electronic image into a central processing unit (CPU);
producing a multi-layer (Multiple layered) laminated protective decorative cover by processing the downloaded electronic image in the central CPU at a design station with raster image processing (RIP) to form a processed image, said processing being selected from the group consisting of color management, color enhancement, color correction, color profiles, replication, creating a seamless pattern, color replacement, and combinations of the preceding;
printing the processed image on media to form a printed media;
heating and drying the printed media;
laminating the dried printed media to form the multi-layer laminated protective decorative cover providing a wrap;
said multi-layer laminated protective decorative cover comprising;
an outer transparent laminated layer;
an intermediate decorative layer comprising said printed media, said intermediate decorative layer having a front decorative surface and a back surface; and said media comprising a pressure sensitive sheet;
an adhesive layer comprising adhesive portions on the back surface of said printed media;
an inner removable backing layer providing a backer;
protecting and decorating a product including installing and applying the multi-layer laminated protective decorative cover to a surface of the product, other than, in the absence of and excluding a cooler and an outside exterior surface of a mode of transportation selected from the group consisting of a racecar, truck, bus, vehicle, train and boat, by preparing the surface of the product by removing from the surface any fixtures, handles, outlet cover or detachable external parts;
aligning and positioning the multi-layer laminated protective decorative cover on the surface;
detachably taping the multi-layer laminated protective decorative cover with masking tape to the surface;
fractionating the multi-layer laminated protective decorative cover to form a temporary hinge with the tape;
peeling and removing part of the backer in proximity to the hinge to expose part of the adhesive layer;
severing and disposing the removed part of the backer;
pressing, flattening and securing the exposed part of the adhesive layer of the multi-layer laminated protective decorative cover against the surface of the product by firmly wiping the laminated layer with back and forth movements of a squeegee;
removing the tape and hinge;
peeling and removing another part of the backer to expose another part of the adhesive layer;
severing and disposing the removed other part of the backer;
pressing, flattening and securing the other exposed part of the adhesive layer of the multi-layer laminated protective decorative cover against the surface of the product by firmly wiping the laminated layer with back and forth movements of the squeegee;
trimming excess portions the multi-layer laminated protective decorative cover extending over the edges of the product;
venting air bubbles from the multi-layer laminated protective decorative cover; and
heating the multi-layer laminated protective decorative cover securely against the surface of the product.

12. A decorative and protective covering process in accordance with claim 11 wherein:
said items are selected from the group consisting of tiles, stone, granite, marble, grout, wood and combinations thereof; and
said image is selected from the group consisting of: tile, stone, marble, granite, grout, wood, a solid color, metallic color, stainless steel, pattern, text, words, numbers, alpha numeric images, characters, symbols, logos, designs, colored indicia, black indicia, graphics, picture, design, decorative image and combinations of any of the preceding.

13. A decorative and protective covering process in accordance with claim 11 wherein said preparing the surface includes one or more of the following:
degreasing the surface;
wiping the surface with isopropyl alcohol;
coating the surface with a primer; and
applying an adhesive promoter, the surface.

14. A decorative and protective covering process in accordance with claim 11 wherein said CPU is selected from the group consisting of: laptop computer, desktop computer, portable computer, personal computer, microprocessor, computer system, tablet computer, wireless computer, wired computer; netbook, electronic communications device, portable networking device, a radiotelephone, a cellular (cell) phone, a mobile phone, smart phone, flip phone, slider phone, android phone, tablet phone, camera phone, clamshell device, portable networking device, qwerty flip device, wireless device, portable mobile communications device, personal digital assistant (PDA), wireless e-mail device, internet communication device, android tablet, ipod, ipad, blackberry, tablet device, hand held electronic device, mobile electronic device, and combinations of any of the preceding.

15. A decorative and protective covering process in accordance with claim 11 wherein said product is selected from the group consisting of a door, wall, cabinet, countertop, table, backsplash, wall tile, shower surround, refrigerator, dishwasher, gas grill, furniture, air conditioner, elevator, garage door, floor, ceiling, toilet, window sill, window frame, door frame, shelf and combinations of any of the preceding.

16. A decorative and protective covering process in accordance with claim 11 wherein said product is used and located in an area selected from the group consisting of: a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured homes, apartment, restaurant, house, home, hotel, motel, hospital, nursing home, mobile home, interior of recreational vehicle (RV), trailer, interior of boat, interior of train, interior of bus, rehabs, rental unit, condominium, single family home, town home, gazebo, porch, outdoor bar, grilling area, an interior inside surface, and combinations of any of the preceding.

17. A decorative and protective covering system, comprising
a composite assembly comprising a product and a multiple layer laminated protective cover;
said product having at least one surface, other than, in the absence of and excluding a cooler and an outside exterior surface of a mode of transportation selected from the group consisting of a racecar, truck, bus, vehicle, train and boat;
said multiple layered (multi-layer) laminated protective decorative cover providing a wrap securely bonded to, covering and protecting said surface of said product,
said multiple layered laminated protective decorative cover comprising;
an outer transparent laminated layer;
an intermediate decorative layer comprising printed media, said intermediate decorative layer having a front decorative surface and a back surface; and said media comprising a pressure sensitive sheet; and
an adhesive layer comprising adhesive portions on the back surface of said printed media.

18. A decorative and protective covering system in accordance with claim 17 wherein said multiple layered laminated protective decorative cover comprises an inner removable backing layer providing a backer.

19. A decorative and protective covering system in accordance with claim 17 wherein said printed media comprises an image selected from the group consisting of: tile, stone, marble, granite, grout, wood, a solid color, metallic color, stainless steel, at least one pattern, text, words, numbers, alpha numeric images, characters, symbols, logos, designs, colored indicia, black indicia, graphics, picture, design, decorative image and combinations of any of the preceding.

20. A decorative and protective covering system in accordance with claim 17 wherein:
said product is selected from the group consisting of a door, wall, cabinet, countertop, table, backsplash, wall tile, shower surround, refrigerator, dishwasher, gas grill, furniture, air conditioner, elevator, garage door, floor, ceiling, toilet, window sill, window frame, door frame, shelf and combinations of any of the preceding; and
said product is used and located in an area selected from the group consisting of a kitchen, bathroom, offices, garage, lobby, foyer, entryway, dining room, living room, family room, bedroom, bathroom, shower, bar, pantry, basement, utility room, garage, laundry room, den, movie theater, theater, stage, stage scenery, studio set, recreation room, clubhouse, conference room, office, store, motor home, pre-manufactured homes, apartment, restaurant, house, home, hotel, motel, hospital, nursing home, mobile home, interior of recreational vehicle (RV), interior of a trailer, interior of boat, interior of train, interior of bus, rehabs, rental unit, condominium, single family home, town home, gazebo, porch, outdoor bar, grilling area an interior inside surface, and combinations of any of the preceding.
